(19) United States
(12) Patent Application Publication
(10) Pub. No.: US 2025/0187879 A1
(43) Pub. Date: Jun. 12, 2025

(54) STEP OF PASSENGER CONVEYOR AND PASSENGER CONVEYOR

(71) Applicant: Otis Elevator Company, Farmington, CT (US)

(72) Inventor: Xia Jing, Hangzhou (CN)

(21) Appl. No.: 18/975,345

(22) Filed: Dec. 10, 2024

(30) Foreign Application Priority Data
Dec. 12, 2023 (CN) 202323401292.3

(51) Int. Cl. B66B 23/12; B66B 21/04; B66B 23/14

(52) U.S. Cl. CPC B66B 23/12; B66B 21/04; B66B 23/14

(57) ABSTRACT

A step of a passenger conveyor and a passenger conveyor. The step is provided with a step anti-jump member which includes: a first portion connected to a frame of the step, and a second portion connected to the first portion and extending towards a step guide rail, after a plurality of steps are connected by a step chain and assembled in place on the step guide rail, preset gaps are maintained between the second portion and the step guide rail, and when an upward jump displacement of the step exceeds a preset value during a travelling of the step along the step guide rail, the second portion comes into contact with the step guide rail to limit the step from continuing to jump upward.

### FOREIGN PRIORITY

This application claims priority to Chinese Patent Application No. 202323401292.3, filed Dec. 12, 2023, and all the benefits accruing therefrom under 35 U.S.C. § 119, the contents of which in its entirety are herein incorporated by reference.

### TECHNICAL FIELD OF INVENTION

The present disclosure relates to a conveying system, in particular to a step of a passenger conveyor and a passenger conveyor.

### BACKGROUND OF THE INVENTION

At present, passenger conveyor systems such as escalators and moving walks have been widely used in many places, which bring great convenience to people's work, production, and travel. The local structure of an existing passenger conveyor is shown in FIGS. 1 and 2, in which parts such as a step 1a and a step track 2a are shown. For safety reasons, an independent emergency track 2b and corresponding support structures are usually arranged near the step track 2a, and step hooks 1b are installed on the step 1a. During the operation of the passenger conveyor, when the step 1a encounters certain situations, it may jump upward and move due to malfunction. At this point, the step hooks 1b installed on the step 1a are blocked by the emergency tracks 2b, so as to prevent the step 1a from continuing to jump upward and avoid the step thrust force being too large, playing the function of anti-jump protection of the step. In order to ensure the reliable operation of these emergency tracks 2b, it is necessary to repeatedly adjust and confirm the positioning and structural dimensions of relevant components during installation and maintenance. For example, FIG. 2 exemplarily illustrates that the horizontal gap S1 and the vertical gap S2 between the emergency track 2b and the step track 2a need to meet the application requirements after assembly.

### SUMMARY OF THE INVENTION

In view of the foregoing, the present disclosure provides a step of a passenger conveyor and a passenger conveyor, so as to solve or at least alleviate one or more of the aforementioned problems and other problems in the prior art, or to provide alternative technical solutions for the prior art.

According to one aspect of the present disclosure, a step of a passenger conveyor is firstly provided, wherein the step is provided with a step anti-jump member, the step anti-jump member comprising: a first portion connected to a frame of the step; and a second portion connected to the first portion and extending towards a step guide rail, wherein after a plurality of steps are connected by a step chain and assembled in place on the step guide rail, preset gaps are maintained between the second portion and the step guide rail, and when an upward jump displacement of the step exceeds a preset value during a travelling of the step along the step guide rail, the second portion comes into contact with the step guide rail to limit the step from continuing to jump upward.

In a step of a passenger conveyor according to the present disclosure, optionally, the step anti-jump member is provided below a roller shaft seat located on both sides of the step, the first portion is perpendicular to an axis of roller of the step, and the second portion is parallel to the axis.

In a step of a passenger conveyor according to the present disclosure, optionally, the second portion is arranged below a rail surface of the step guide rail and is provided with a protrusion which comes into contact with the step guide rail when the upward jump displacement of the step exceeds the preset value and is configured to have a gradually decreasing cross-sectional area in a direction facing and perpendicular to the rail surface.

In a step of a passenger conveyor according to the present disclosure, optionally, a top of the protrusion is configured into a circular arc shape, and a yield strength of the protrusion is not greater than a yield strength of the step guide rail.

In a step of a passenger conveyor according to the present disclosure, optionally, a part of the second portion that extends below the rail surface is not less than half of a length of the second portion.

In a step of a passenger conveyor according to the present disclosure, optionally, the first portion and/or the second portion are provided with a reinforcing rib structure, and/or the first portion is integrally formed with the second portion, and/or the first portion, the second portion and the frame of the step are integrally formed.

In a step of a passenger conveyor according to the present disclosure, optionally, the preset gaps between the second portion and the step guide rail include a horizontal gap and a vertical gap, and the horizontal gap is within a range of 7-10 mm and the vertical gap is within a range of 5-8 mm.

In addition, according to another aspect of the present disclosure, a passenger conveyor is further provided, comprising: a truss fixed and installed on site; a step guide rail installed on the truss; and a plurality of steps of a passenger conveyor according to any of the above, connected by a step chain and assembled on the step guide rail, wherein the second portion of the step anti-jump member maintains preset gaps with the step guide rail, and comes into contact with the step guide rail to limit the step from continuing to jump upward when an upward jump displacement of the step exceeds a preset value during a travelling of the step along the step guide rail.

In a passenger conveyor according to the present disclosure, optionally, the rail surface of the step guide rail has an extension portion extending horizontally towards the step anti-jump member and a groove portion located below the extension portion, and a part of the second portion is arranged within the groove portion.

In a passenger conveyor according to the present disclosure, optionally, the step guide rail is a sheet metal bending member, and the step guide rail has a thickness range of 4-6 mm and the groove portion has a depth range of 12-18 mm.

The solutions of the disclosure innovatively improve the structures of the step and the step guide rail of a passenger conveyor, which eliminates the configuration of additional emergency track in the system. This not only saves materials and manpower investment, but also improves the on-site installation efficiency of the passenger conveyor and reduces construction difficulty. By adopting the solutions of the disclosure, the possibility of failure of the passenger conveyor during operation due to human installation errors, loosening or deformation of connecting parts of original emergency track, etc., can be significantly reduced, thereby improving the safety performance of the passenger conveyor.

### BRIEF DESCRIPTION OF THE DRAWINGS

The technical solutions of the present disclosure will be described in further detail below with reference to the accompanying drawings and embodiments. However, it should be understood that these drawings are designed merely for the purpose of explanation and only intended to conceptually illustrate the structures and configurations described herein, and are not required to be drawn to scale.

FIG. 1 is a local three-dimensional structural schematic diagram of a step, an adjacent step track, an emergency track, and a truss in an existing passenger conveyor.

FIG. 2 is a side-view structural schematic diagram of the step track, emergency track, and truss in the existing passenger conveyor shown in FIG. 1.

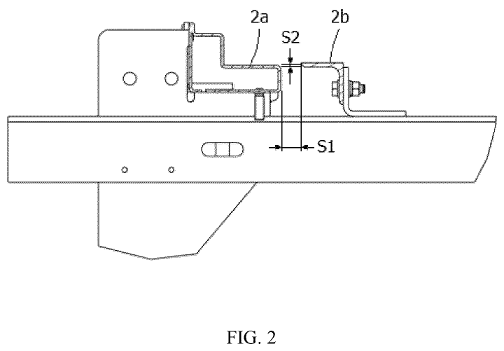

FIG. 3 is a three-dimensional structural schematic diagram of an embodiment of an escalator according to the present disclosure.

FIG. 4 is a local three-dimensional structural schematic diagram of a step, an adjacent step track, and a truss in the embodiment of an escalator shown in FIG. 3.

FIG. 5 is another local three-dimensional structural schematic diagram of the step, adjacent step track, and truss shown in FIG. 4.

FIG. 6 is a side-view structural schematic diagram of the step, adjacent step track, and truss shown in FIG. 4.

FIG. 7 is a local three-dimensional structural schematic diagram of a step in the embodiment of an escalator shown in FIG. 3.

FIG. 8 is another local three-dimensional structural schematic diagram of a step in the embodiment of an escalator shown in FIG. 3.

### DETAILED DESCRIPTION OF THE INVENTION

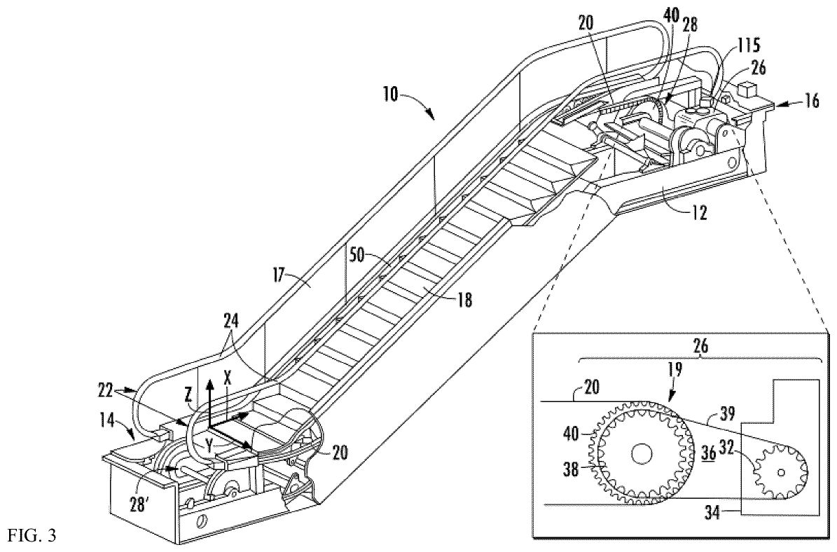

FIG. 3 illustrates an escalator 10. It should become apparent in the ensuing description that the present disclosure is applicable to other passenger conveyors, such as moving walks. The escalator 10 generally includes a truss 12 extending between a lower landing 14 and an upper landing 16, wherein the truss 12 is fixedly installed on site. A plurality of sequentially connected steps or tread plates 18 are connected to a step chain 20 and travel through a closed loop path within the truss 12 along a guide rail 23 fixedly connected onto the truss, thus forming a conveying section for carrying passengers. A pair of balustrades 22 includes moving handrails 24. A drive machine 26, or drive system, is typically located in a machine space 28 under the upper landing 16. However, an additional machine space 28′ may be located under the lower landing 14. The drive machine 26 is configured to drive the steps 18 and/or handrails 24 through the step chain 20. The drive machine 26 operates to move the tread plates 18 in a chosen direction at a desired speed under normal operating conditions.

The steps 18 make a 180 degree heading change in a turn-around area 19 located under the lower landing 14 and upper landing 16. The steps 18 are pivotally attached to the step chain 20 and follow a closed loop path of the step chain 20, running from one landing to the other, and back again.

The drive machine 26 includes a first drive member 32, such as motor output sheave, connected to a drive motor 34 through a belt reduction assembly 36 including a second drive member 38, such as an output sheave, driven by a drive chain 39, such as an output belt. The first drive member 32 in some embodiments is a driving member, and the second drive member 38 is a driven member.

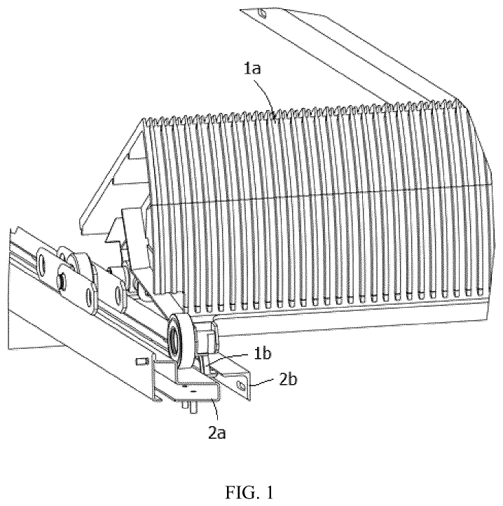

As used herein, the first drive member 32 and/or the second drive member 38, in various embodiments, may be any type of rotational device, such as a sheave, pulley, gear, wheel, sprocket, cog, pinion, etc. The drive chain 39, in various embodiments, may be configured as a chain, belt, cable, ribbon, band, strip, or any other similar device that operatively connects two elements to provide a driving force from one element to another. For example, the drive chain 39 may be any type of interconnecting member that extends between and operatively connects the first drive member 32 and a second drive member 38. In some embodiments, as shown in FIG. 1, the first drive member 32 and the second drive member may provide a belt reduction. For example, first drive member 32 may be approximately 75 mm (2.95 inches) in diameter while the second drive member 38 may be approximately 750 mm (29.53inches) in diameter. The belt reduction, for example, allows the replacement of sheaves to change the speed for 50 or 60 Hz electrical supply power applications, or different step speeds. However, in other embodiments, the second drive member 38 may be substantially similar to the first drive member 32.

As noted, the first drive member 32 is driven by drive motor 34 and thus is configured to drive the drive chain 39 and the second drive member 38. In some embodiments, the second drive member 38 may be an idle gear or similar device that is driven by the operative connection between the first drive member 32 and the second drive member 38 by means of drive chain 39. The drive chain 39 travels around a loop set by the first drive member 32 and the second drive member 38, which hereinafter may be referred to as a small loop. The small loop is provided for driving a larger loop which consists of the step chain 20, and is driven by an output sheave 40, for example. Under normal operating conditions, the drive chain 39 and the step chain 20 move in unison, based upon the speed of movement of the first drive member 32 as driven by the drive motor 34.

The escalator 10 also includes a controller 115 that is in electronic communication with the drive motor 34. The controller 115 may be located, as shown, in the machine space 28 of the escalator 10 and is configured to control the operation of the escalator 10. For example, the controller 115 may provide drive signals to the drive motor 34 to control the acceleration, deceleration, stopping, etc. of the steps 18 through the step chain 20. The controller 115 may be an electronic controller including a processor and an associated memory comprising computer-executable instructions that, when executed by the processor, cause the processor to perform various operations. The processor may be, but is not limited to, a single-processor or multi-processor system of any of a wide array of possible architectures, including field programmable gate array (FPGA), central processing unit (CPU), application specific integrated circuits (ASIC), digital signal processor (DSP) or graphics processing unit (GPU) hardware arranged homogenously or heterogeneously. The memory may be but is not limited to a random access memory (RAM), read only memory (ROM), or other electronic, optical, magnetic or any other computer readable medium.

Although described herein as a particular escalator drive system and particular components, this is merely exemplary, and those of skill in the art will appreciate that other escalator system configurations may operate with the invention disclosed herein.

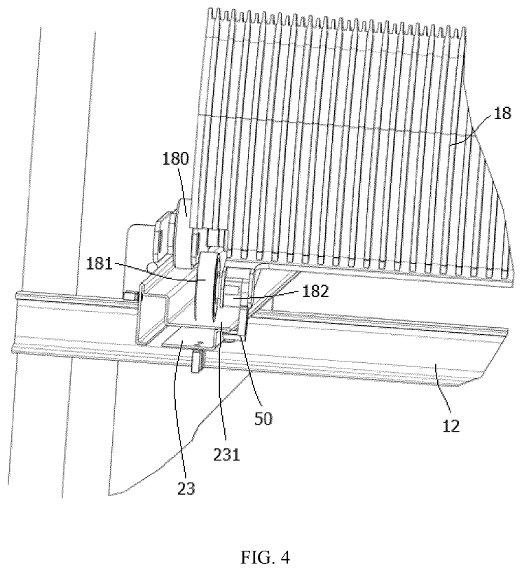

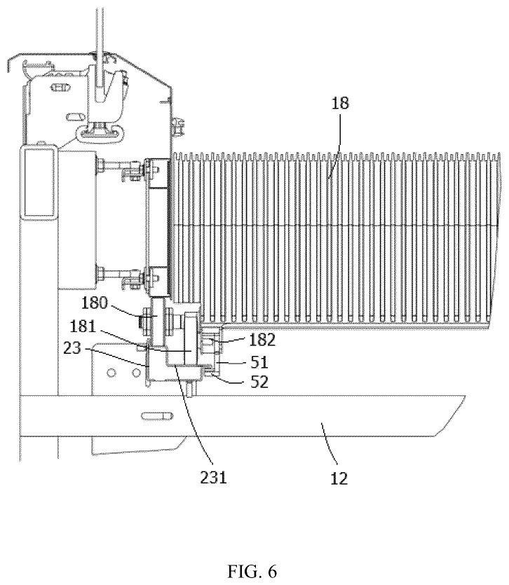

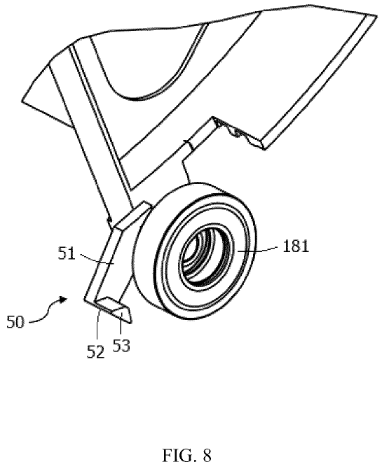

By referring to FIGS. 4 to 8, step anti-jump members 50 can be configured on one or more steps 18 of the escalator 10 according to application needs, so that it is not necessary to install an additional emergency track separately in escalator 10 as in the prior art shown in FIG. 1. The function of the emergency track will be integrated into the step tracks 23, which will effectively save costs in terms of materials, manpower, etc., reduce the difficulty of on-site installation and maintenance operations, and improve efficiency. It can also improve the operational reliability of the step tracks and the steps.

As used herein, in various embodiments, the step anti-jump member 50 may include a first portion 51 and a second portion 52, both of which may use the same or different materials such as both using materials such as aluminum alloy or cast iron. The first portion 51 and the second portion 52 can be manufactured separately, and then connected together using techniques such as welding. Of course, in one or some embodiments, the first portion 51 and the second portion 52 can also be integrally formed. For example, the first portion 51 and the second portion 52 can be integrally formed into a configuration that meets the design requirements through die casting using suitable materials such as die cast aluminum alloy YL102. In addition, optionally, the present disclosure allows the first portion 51 and second portion 52 of the step anti-jump member 50 to be integrally formed with the frame of the step 18 to form an overall structure, so as to improve structural reliability and facilitate installation and maintenance. Optionally, whether it is the first portion 51 or the second portion 52, they can be provided with structures such as reinforcing ribs as needed to further enhance the mechanical structural performance of the step anti-jump members.

The first portion 51 of the step anti-jump member 50 is connected to the frame of the step 18. As used herein, for example, the first portion 51 of the step anti-jump member 50 can be installed and connected below the roller shaft seat 182 for supporting the roller 181 located on both sides of the step 18. And, the first portion 51 and the axis of the roller 181 can be made in a substantially perpendicular relationship, and the second portion 52 and the axis of the roller 181 can be made in a substantially parallel relationship.

The second portion 52 of the step anti-jump member 50 is configured to extend towards the step guide rail 23. After connecting these steps 18 to form a closed loop through the step chain 20 and assembling them in place in the escalator 10, preset gaps can be maintained between the second portion 52 and the step guide rail 23 as needed. That is, the above gaps can be designed, configured, and adjusted according to specific application requirements. For example, the horizontal gap between the second portion 52 and the step guide rail 23 can be configured to be within the range of 7-10 mm, and the vertical gap between them can be configured to be within the range of 5-8 mm. For example, the horizontal gap and vertical gap can be controlled to 8 mm and 6 mm respectively after assembly, and so on. When powered by the drive machine 26, the step 18 will be driven along with the step chain 20 to move along the step guide rail 23. Once abnormal situations occur, such as the roller 181 or roller 180 of the step 18 (which are embodied as secondary and main wheels in the given example) being blocked by foreign objects, such as the roller encountering small stones, small objects dropped by passengers on the tracks, etc., it will cause step 18 to jump upward and the upward displacement may exceed the preset value (which can be configured as needed and corresponds to the aforementioned vertical gap). At this point, the second portion 52 of the step anti-jump member 50 will also move upwards, and then comes into contact with the step guide rail 23 to be obstructed by the latter, so that the step 18 can be limited from continuing to jump up, so as to avoid possible damages to components such as the step 18, thus playing a role of step anti-jump protection, and effectively ensuring the safe operation of the system.

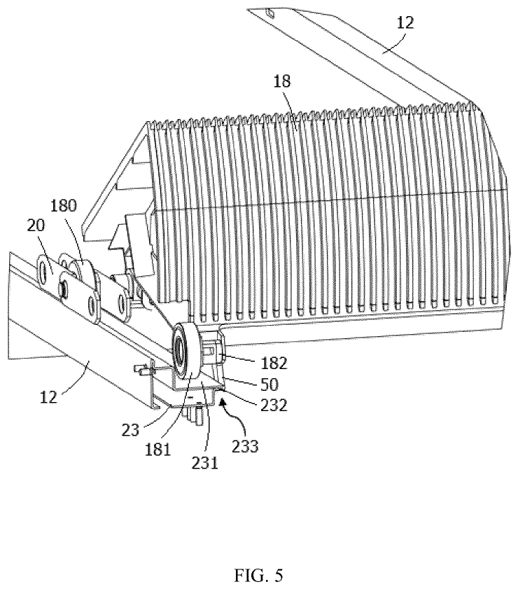

Through the combined use of the step anti-jump member 50 and the step guide rail 23, it is not necessary to install and use an emergency track that are widely configured in existing passenger conveyors in the escalator 10. As used herein, in various embodiments, the step guide rail 23 and the step anti-jump member 50 can be arranged adjacent to each other, and the rail surface 231 of the step guide rail 23 can be configured to extend horizontally towards the step anti-jump member 50 to form an extension portion 232. By use of the extension portion 232, a groove portion 233 located below it is formed, as shown schematically in FIG. 5 and other figures. In various embodiments, a part of the second portion 52 can be arranged within the space formed by the groove portion 233. For example, the length of this portion can be selected to be not less than half of the length of the second portion 52, so that in the event of a step jump-up, a relatively large contact area can be formed by moving the above portion upwards to rest against underneath the rail surface 231 of the step guide rail 23, so as to achieve a better effect of limiting the continued jump up and movement of the step 18.

As an example, the step guide rail 23 can be formed using sheet metal parts by means of bending processing technology. The material used, thickness, length, and other aspects of the step guide rail 23 can be configured as needed. For example, the thickness can be configured within the range of 4-6 mm, the depth of the groove 233 can be configured within the range of 12-18 mm, and so on. The present disclosure does not make specific restrictions in this regard.

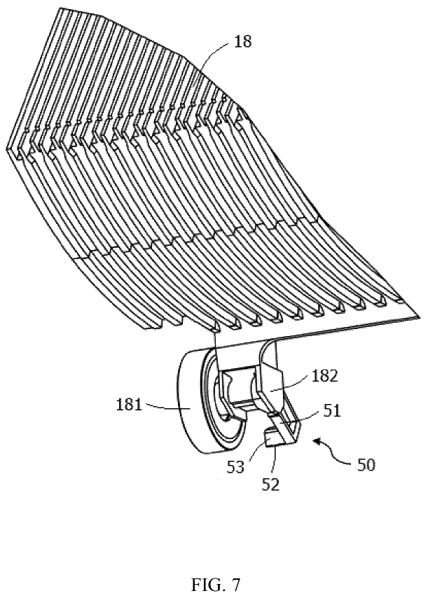

As shown in FIG. 7, in one or more embodiments, a protrusion 53 can be provided on the second portion 52 of the step anti-jump member 50. In the event of a step jumps-up where the upward displacement exceeds the preset value, such protrusions 53 can be used to make contact with the step guide rail 23, so that the contact limit operation between the step anti-jump member 50 and the step guide rail 23 can be controlled through the contact parts, contact forces, material wear, etc. that meet specific expectations, and a better step anti-jump protection effect that meets actual requirements can be achieved.

As a feasible configuration option, the protrusion 53 can be configured to have a gradually decreasing cross-sectional area in the vertical direction facing the rail surface 231 of the step guide rail 23, such as a roughly “ [symbol] ” shaped configuration as shown in FIG. 7. In addition, the top of the protrusion 53 can be constructed into a circular arc shape to reduce the possible impacts on impact, noise, and other aspects when the step anti-jump member 50 and the step guide rail 23 come into contact. Optionally, the protrusion 53 can be configured so that its yield strength is not greater than that of the step guide rail 23, so as to better protect the relatively more important step guide rail 23. For example, in the case of using material Q235B for the step guide rail 23 and material YL102 for step anti-jump member 50, the yield strength of the latter can be roughly half of the former.

By adopting the solutions of the disclosure, emergency tracks widely configured and used in existing equipment can be eliminated in the passenger conveyor, while the step anti-jump function is integrated into the conventional step guide rail used in combination with the step anti-jump member. For steps, step chains, step guide rails, etc. installed with the anti-jump members, as long as they meet the requirements of product design and production, only routine operations are required during assembly. This, therefore, eliminates the need for tedious installation and adjustment operations between emergency tracks, step guide rails, steps, etc., as in existing technical solutions, which can greatly save manpower and material costs, significantly reduce the possibility of equipment failures caused by human caused installation errors, loose connections or deformation of the emergency tracks and other factors in the existing emergency track installation process, thereby enhancing the safety and reliability of the passenger conveyor.

A step of a passenger conveyor and a passenger conveyor according to the present disclosure have been described above in detail by way of examples only. These examples are merely used to illustrate the principles and embodiments of the present disclosure, rather than limiting the present disclosure. Various modifications and improvements can be made by those skilled in the art without departing from the scope of the present disclosure. Therefore, all equivalent technical solutions should fall within the scope of the present disclosure and be defined by the claims of the present disclosure.

What is claimed is:

1. A step of a passenger conveyor, wherein the step is provided with a step anti-jump member which comprises:
a first portion connected to a frame of the step; and
a second portion connected to the first portion and extending towards a step guide rail, wherein after a plurality of steps are connected by a step chain and assembled in place on the step guide rail, preset gaps are maintained between the second portion and the step guide rail, and when an upward jump displacement of the step exceeds a preset value during a travelling of the step along the step guide rail, the second portion comes into contact with the step guide rail to limit the step from continuing to jump upward.

2. The step of a passenger conveyor according to claim 1, wherein the step anti-jump member is provided below a roller shaft seat located on both sides of the step, the first portion is perpendicular to an axis of roller of the step, and the second portion is parallel to the axis.

3. The step of a passenger conveyor according to claim 1, wherein the second portion is arranged below a rail surface of the step guide rail and is provided with a protrusion which comes into contact with the step guide rail when the upward jump displacement of the step exceeds the preset value and is configured to have a gradually decreasing cross-sectional area in a direction facing and perpendicular to the rail surface.

4. The step of a passenger conveyor according to claim 3, wherein a top of the protrusion is configured into a circular arc shape, and a yield strength of the protrusion is not greater than a yield strength of the step guide rail.

5. The step of a passenger conveyor according to claim 3, wherein a part of the second portion that extends below the rail surface is not less than half of a length of the second portion.

6. The step of a passenger conveyor according to claim 1, wherein the first portion and/or the second portion are provided with a reinforcing rib structure, and/or the first portion is integrally formed with the second portion, and/or the first portion, the second portion and the frame of the step are integrally formed.

7. The step of a passenger conveyor according to claim 1, wherein the preset gaps between the second portion and the step guide rail include a horizontal gap and a vertical gap, and the horizontal gap is within a range of 7-10 mm and the vertical gap is within a range of 5-8 mm.

8. A passenger conveyor, comprising:
a truss fixed and installed on site;
a step guide rail installed on the truss; and
a plurality of steps of a passenger conveyor according to claim 1, connected by a step chain and assembled on the step guide rail, wherein the second portion of the step anti-jump member maintains preset gaps with the step guide rail, and comes into contact with the step guide rail to limit the step from continuing to jump upward when an upward jump displacement of the step exceeds a preset value during a travelling of the step along the step guide rail.

9. The passenger conveyor according to claim 8, wherein the rail surface of the step guide rail has an extension portion extending horizontally towards the step anti-jump member and a groove portion located below the extension portion, and a part of the second portion is arranged within the groove portion.

10. The passenger conveyor according to claim 9, wherein the step guide rail is a sheet metal bending member, and the step guide rail has a thickness range of 4-6 mm and the groove portion has a depth range of 12-18 mm.
